(19) United States
(12) Patent Application Publication
(10) Pub. No.: US 2011/0307778 A1
(43) Pub. Date: Dec. 15, 2011

(54) MOBILE ELECTRONIC APPARATUS AND METHOD OF SWITCHING APPLICATION PROGRAMS THEREOF

(75) Inventors: Chieh-Chih Tsai, Taipei (TW); Yu-Mao Feng, Taipei (TW)

(73) Assignee: ACER INCORPORATED, Taipei County (TW)

(21) Appl. No.: 12/797,630

(22) Filed: Jun. 10, 2010

(51) Int. Cl. G06F 9/46; G06F 3/01; G06F 3/048

(52) U.S. Cl. 715/702; 719/328; 715/830

(57) ABSTRACT

The present invention discloses a mobile electronic apparatus and a method of switching application programs thereof, the method is applied for the mobile electronic apparatus which has a screen, a storing unit and a processing unit, and the method comprises the following steps of: executing a plurality of application programs by the processing unit; capturing a plurality of frames displayed on the screen of the application programs then storing the frames in the storing unit; displaying the frames in a list on the screen with a sequence of the frames according to the starting time of each application program; executing the application program when the corresponding frame displayed in the list being selected by a user; wherein at least one of the application programs is closed before displaying the list on the screen.

### FIELD

The exemplary embodiment(s) of the present invention relates to a field of mobile electronic apparatus and a method of switching application programs thereof. More specifically, the exemplary embodiment(s) of the present invention relates to a switch method on a mobile electronic apparatus for switching different application programs both being executed or closed.

### BACKGROUND

The conventional method of switching application programs applied for a mobile electronic apparatus like a cell phone only allows a user to switch different application programs being executed. Thus, if the user wants to pause an application program being used and executes another closed application program, the user needs to temporarily exit the former application program and restart the later application program, and this is very inconvenient for the people needs to switch lots of different application programs at the same time because the user has to execute these application programs simultaneously, and this will exhaust the memory of the cell phone or lower the efficiency of the cell phone.

### SUMMARY

To solve the problems in the conventional arts, it is a primary object of the present invention to provide a mobile electronic apparatus and a method of switching application programs thereof to solve the problem that the application programs need to be executed at the same time when a user wants to switch one application program to another.

To achieve the above object, a method of switching application programs according to the present invention applied for a mobile electronic apparatus having a screen, a storing unit and a processing unit, and the method comprises the following steps of: executing a plurality of application programs by the processing unit; capturing a plurality of frames displayed on the screen of the application programs then storing the frames in the storing unit; displaying the frames in a list on the screen with a sequence of the frames according to the starting time of each application program; executing the application program when the corresponding frame displayed in the list being selected by a user; wherein at least one of the application programs is closed.

Wherein the mobile electronic apparatus is a mobile phone, a personal digital assistant, a smart phone, a netbook or a navigator.

Wherein the frames of the closed application program are captured just right before the application programs are closed.

Wherein the frame having an earlier starting time is arranged in the front of the list.

Wherein the screen is a touch-controlled screen, and if the number of the frames displayed in the list is more then the capacity of the touch-controlled screen, then the frames are able to be touched and dragged in a predetermined direction by the user through the touch-controlled screen to show the frames not being shown on the screen.

Wherein the frame having a later starting time is arranged in the front of the list.

Wherein the screen is a touch-controlled screen, and when the number of the frames displayed in the list is more then the capacity of the touch-controlled screen, then the frames are able to be touched and dragged in a predetermined direction by the user through the touch-controlled screen to show the frames not being shown on the screen.

To achieve the above object, a mobile electronic apparatus according to the present comprises a screen, a storing unit and a processing unit. The screen displays a plurality of frames of a plurality of application programs and the storing unit stores the frames. The processing unit executes the application programs, captures the frames of the application programs displayed on the screen, and then stores the frames in the storing unit, displays the frames in a list on the screen with a sequence of the frames according to the starting time of each application program, and executes the application program when the corresponding frame displayed in the list being selected by a user; wherein at least one of the application programs is closed.

Wherein the mobile electronic apparatus is a mobile phone, a personal digital assistant, a smart phone, a netbook or a navigator.

Wherein the frames of the closed application program are captured just right before the application programs are closed.

Wherein the frame having an earlier starting time is arranged in the front of the list.

Wherein the screen is a touch-controlled screen, and if the number of the frames displayed in the list is more then the capacity of the touch-controlled screen, then the frames are able to be touched and dragged in a predetermined direction by the user through the touch-controlled screen to show the frames not being shown on the screen.

Wherein the frame having a later starting time is arranged in the front of the list.

Wherein the screen is a touch-controlled screen, and when the number of the frames displayed in the list is more then the capacity of the touch-controlled screen, then the frames are able to be touched and dragged in a predetermined direction by the user through the touch-controlled screen to show the frames not being shown on the screen.

With the above arrangements, the mobile electronic apparatus and the method of switching application programs thereof according to the present invention has one or more of the following advantages:

(1) It may be more convenient for the user who needs to switch different application programs at the same time whether the application programs are executed or not.

(2) The memory of the mobile electronic apparatus could be saved and the efficiency of the mobile electronic apparatus could be raised because the application programs need not to be executed at the same time for waiting to be switched to.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of the electronic apparatus in accordance to the present invention;

FIG. 2 is the first embodiment schematic diagram in accordance to the present invention;

FIG. 3 is the second embodiment schematic diagram in accordance to the present invention;

FIG. 4 is the third embodiment schematic diagram in accordance to the present invention; and

FIG. 5 is a flow chart that illustrates the method of switching application programs in accordance to the present invention.

### DETAILED DESCRIPTION

Exemplary embodiments of the present invention are described herein in the context of a screen unlocking method and an electronic apparatus thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

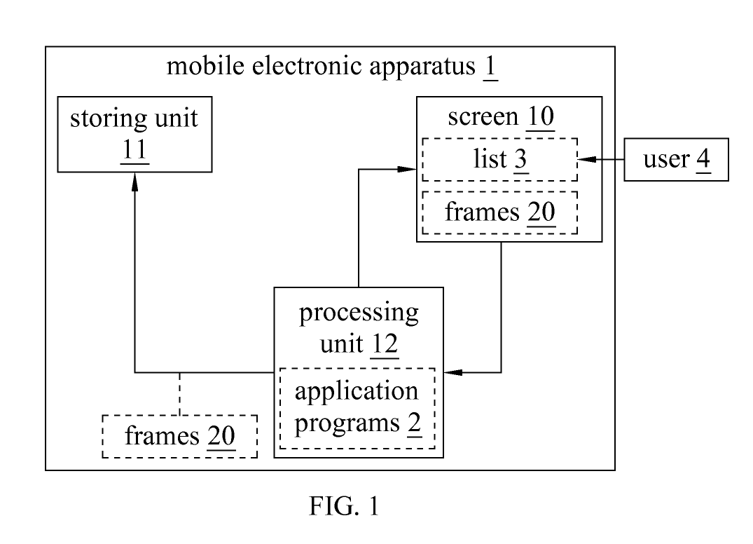

Please refer to FIG. 1, which is a block diagram of the electronic apparatus in accordance to the present invention. As shown in this figure, the mobile electronic apparatus 1 according to the present comprises a screen 10, a storing unit 11 and a processing unit 12. The screen 10 displays a plurality of frames 20 of a plurality of application programs 2 and the storing unit 11 stores the frames 20. The processing unit 12 executes the application programs 2, captures the frames 20 of the application programs 2 displayed on the screen 10, and then stores the frames 20 in the storing unit 11, displays the frames 20 in a list 3 on the screen 10 with a sequence of the frames 20 according to the starting time of each application program 2, and executes the application program 2 when the corresponding frame 20 displayed in the list 3 being selected by a user 4. In some preferred embodiments, at least one of the application programs 2 is closed. In addition, the mobile electronic apparatus 1 could be a mobile phone, a personal digital assistant, a smart phone, a netbook or a navigator. The screen 10 could be a touch-controlled screen; the storing unit 11 could be a memory card or an embedded memory of the mobile electronic apparatus 1; and the processing unit 12 could be a central processing unit (CPU).

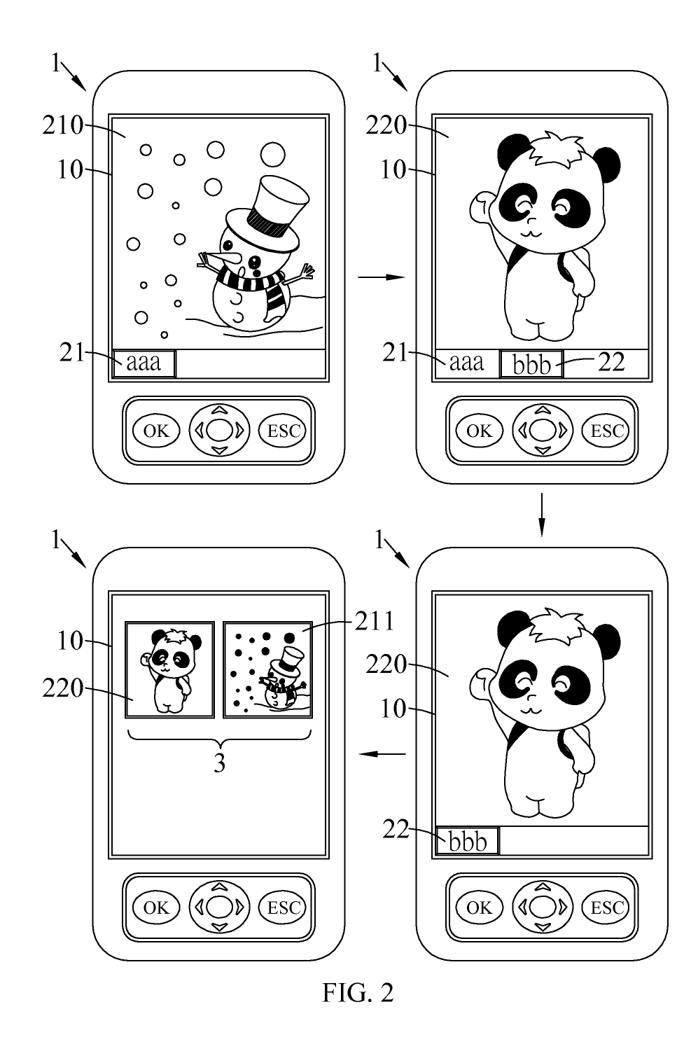

Please refer to FIG. 2, which is the first embodiment schematic diagram in accordance to the present invention. As shown in this figure, a first application program 21 is executed first and a second application program 22 is then executed. At this time, the processing unit (not shown in this figure) records the starting time of each application program into the storing unit (not shown in this figure). The processing unit further captures a first and a second frame 210, 220 of the first application program 21 and the second application program 22, and saves these frames into the storing unit. After that, the first application program 21 is closed, and the processing unit captures a third frame 211 of the first application program 21 right before it is closed then closes the first application program 21. Then the processing unit displays a list 3 on the screen 10, and there are the second frame 220 and the third frame 211 (read by the processing unit from the storing unit) in the list 3, being shrunk to a predetermined size so as to fit the size of the screen 10. Man skilled in the art should understand, though there are only two frames shown in the list 3, the number of the frames shown in the list 3 are able to be increased or decreased depends on the need, and the size of the frames should be correspondingly enlarged or shrunk. It this embodiment, the sequence of the frames 211, 220 from top left to right is according to the starting time stored in the storing unit of the application programs 21, 22, thus the third frame 211 is arranged at the first position, and the second frame 220 is arranged at the second position from top left to right on the screen 10. At this time, if any of the frames 211, 220 displayed in the list 3 is selected by a user (such as being clicked through a keypad or touched through a touch-controlled screen by the user), the processing unit will execute the corresponding application program no matter it is closed or running.

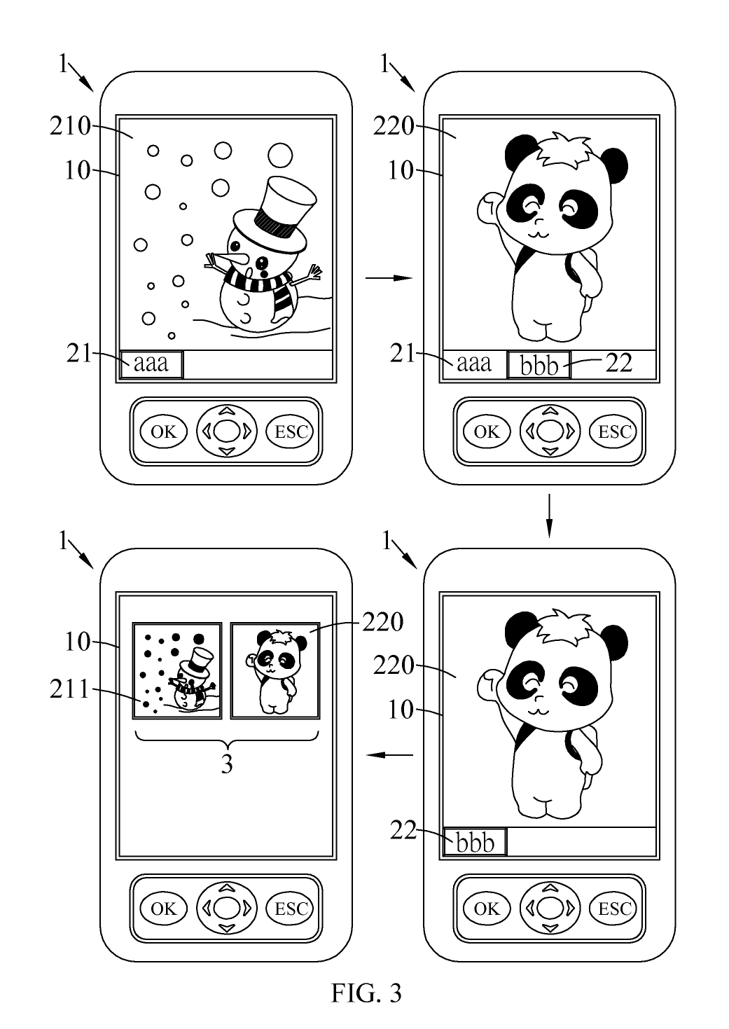

Please refer to FIG. 3, which is the second embodiment schematic diagram in accordance to the present invention. As shown in this figure, the main difference between this embodiment and the first embodiment is that the frame having a later starting time is arranged in the front of the list 3. So the second frame 220 is arranged at the first position and the third frame 211 is arranged at the second position from top left to right on the screen 10. At this time, if any of the frames displayed in the list 3 is selected by a user (such as being clicked through a keypad or touched through a touch-controlled screen by the user), the processing unit will execute the corresponding application program no matter it is closed or running.

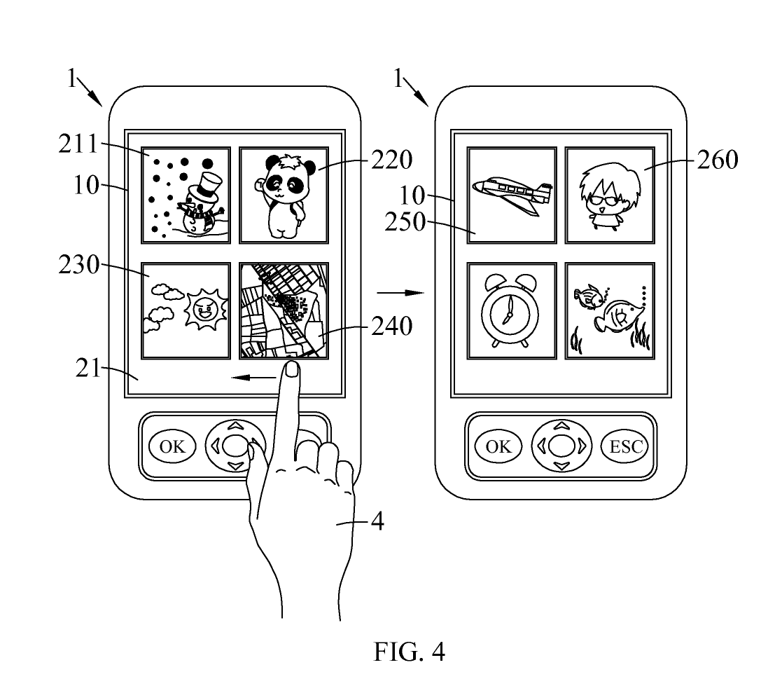

Please refer to FIG. 4, which is the third embodiment schematic diagram in accordance to the present invention. As shown in this figure, the screen 10 is a touch-controlled screen, and when the number of the frames 230, 240 displayed in the list 3 is more then the capacity of the touch-controlled screen 10, then the frames 230, 240 are able to be touched and dragged in a predetermined direction (in this embodiment the predetermined direction is from right to left, but not limited) by a user 4 through the touch-controlled screen 10 to show the frames 250, 260 which is not shown on the previous screen 10. By this way, the user 4 could easily switch from one application program to another without executing these application programs at the same time.

The concept of the method of switching application programs in accordance to the present invention is simultaneously described in the description of the mobile electronic apparatus disclosed in the present invention, but in order to get clearer, the following will still illustrate the flow chart of the method of switching application programs.

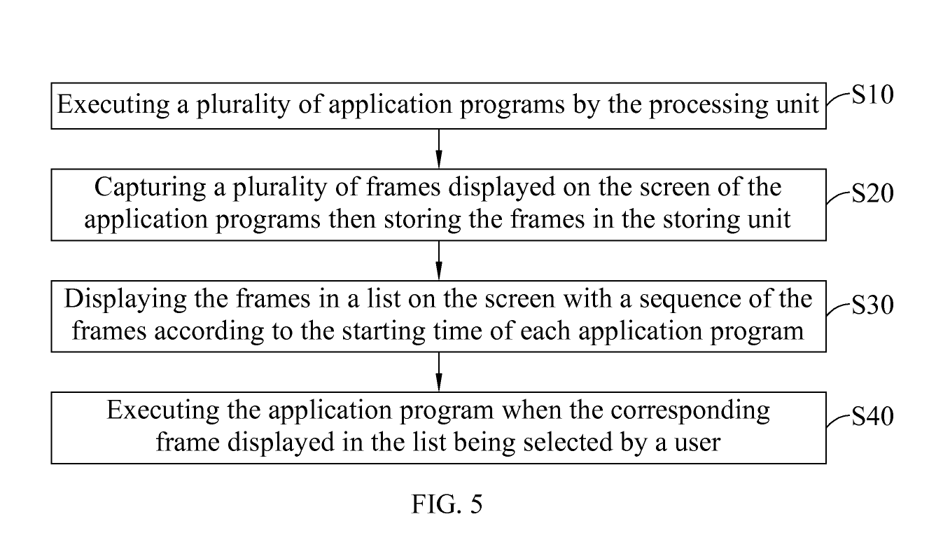

Please refer to FIG. 5, which is a flow chart that illustrates the method of switching application programs in accordance to the present invention. As shown in this figure, the method of switching application programs according to the present invention applied for a mobile electronic apparatus having a screen, a storing unit and a processing unit, the method comprises the following steps of:

(S10) executing a plurality of application programs by the processing unit;

(S20) capturing a plurality of frames displayed on the screen of the application programs then storing the frames in the storing unit;

(S30) displaying the frames in a list on the screen with a sequence of the frames according to the starting time of each application program; and

(S40) executing the application program when the corresponding frame displayed in the list being selected by a user. Wherein at least one of the application programs is closed.

The implementation of the method of switching application programs in accordance with the present invention has already described in the description of the embodiments of the mobile electronic apparatus according to the present invention, so it will not be stated here again.

According to the determining condition aforementioned, the user could easily switch different application programs at the same time whether the application programs are executed or not; moreover, the memory of the mobile electronic apparatus could be saved and the efficiency of the mobile electronic apparatus could be raised because the application programs need not to be executed at the same time for waiting to be switched to.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A method of switching application programs applied for a mobile electronic apparatus having a screen, a storing unit and a processing unit, the method comprising the following steps of:
executing a plurality of application programs by the processing unit;
capturing a plurality of frames displayed on the screen of the application programs then storing the frames in the storing unit;
displaying the frames in a list on the screen with a sequence of the frames according to the starting time of each application program; and
executing the application program when the corresponding frame displayed in the list being selected by a user;
wherein at least one of the application programs is closed.

2. The method of claim 1, wherein the mobile electronic apparatus is a mobile phone, a personal digital assistant, a smart phone, a netbook or a navigator.

3. The method of claim 2, wherein the frames of the closed application program are captured just right before the application programs are closed.

4. The method of claim 3, wherein the frame having an earlier starting time is arranged in the front of the list.

5. The method of claim 4, wherein the screen is a touch-controlled screen, and if the number of the frames displayed in the list is more then the capacity of the touch-controlled screen, then the frames are able to be touched and dragged in a predetermined direction by the user through the touch-controlled screen to show the frames not being shown on the screen.

6. The method of claim 3, wherein the frame having a later starting time is arranged in the front of the list.

7. The method of claim 6, wherein the screen is a touch-controlled screen, and when the number of the frames displayed in the list is more then the capacity of the touch-controlled screen, then the frames are able to be touched and dragged in a predetermined direction by the user through the touch-controlled screen to show the frames not being shown on the screen.

8. A mobile electronic apparatus, comprising:
a screen, displaying a plurality of frames of a plurality of application programs;
a storing unit, storing the frames;
a processing unit, executing the application programs, capturing the frames of the application programs displayed on the screen, and then storing the frames in the storing unit, displaying the frames in a list on the screen with a sequence of the frames according to the starting time of each application program, and executing the application program when the corresponding frame displayed in the list being selected by a user;
wherein at least one of the application programs is closed.

9. The mobile electronic apparatus of claim 8, wherein the mobile electronic apparatus is a mobile phone, a personal digital assistant, a smart phone, a netbook or a navigator.

10. The mobile electronic apparatus of claim 9, wherein the frames of the closed application program are captured just right before the application programs are closed.

11. The mobile electronic apparatus of claim 10, wherein the frame having an earlier starting time is arranged in the front of the list.

12. The mobile electronic apparatus of claim 11, wherein the screen is a touch-controlled screen, and if the number of the frames displayed in the list is more then the capacity of the touch-controlled screen, then the frames are able to be touched and dragged in a predetermined direction by the user through the touch-controlled screen to show the frames not being shown on the screen.

13. The mobile electronic apparatus of claim 10, wherein the frame having a later starting time is arranged in the front of the list.

14. The mobile electronic apparatus of claim 13, wherein the screen is a touch-controlled screen, and when the number of the frames displayed in the list is more then the capacity of the touch-controlled screen, the frames are able to be touched and dragged in a predetermined direction by the user through the touch-controlled screen to show the frames not being shown on the screen.
